(19) United States
(12) Patent Application Publication
(10) Pub. No.: US 2008/0243874 A1
(43) Pub. Date: Oct. 2, 2008

(54) Lightweight Schema Definition

(75) Inventors: Paresh S. Suthar, Redmond, WA (US); Jack E. Ozzie, North Bend, WA (US); Matthew S. Augustine, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/692,700

(22) Filed: Mar. 28, 2007

(51) Int. Cl. G06F 17/00

(52) U.S. Cl. 707/100; 707/E17.008

(57) ABSTRACT

Systems and methods for defining and using schema information with a document are disclosed. In some implementations, schema information may be provided as part of the same document that contains the information to which the schema applies. Such schema information may be used in a variety of ways, including, for example and without limitation, to generate user interfaces that may display or enable editing of the information, to provide programmatic access to the information, to validate information, and so on.

### BACKGROUND

Protocols such as RSS (“Rich Site Summary” or “Really Simple Syndication”) and Atom have become a common way to share and distribute information between endpoints, such as between a variety of computing devices. Often, such protocols define a format for a “document” or “feed document” that contains the information to be shared as well as at least some metadata, or data about the information to be shared. Such feed documents may in turn be represented using a lower-level data-interchange format, such as XML. To share information, one endpoint—perhaps known as a “publisher”—may make available a feed document that another endpoint—a “subscriber”—accesses and from which the other endpoint may obtain information. While uses such as web log and news article syndication were some of the first widespread applications for feed protocols and documents, a feed document may comprise any of a wide variety of types of information, not just web log entries or news articles.

Some of such sharing protocols define ways in which the protocols themselves may be extended or used to communicate additional data, or at least to represent communicated data in such a way that it can be more easily interpreted by other endpoints. In the case of RSS, at least, one such mechanism may be known as a “namespace extension.” As used with RSS, for example, a namespace extension may define new XML elements that may be included in a feed document that conforms to the namespace extension. If information about or a description of the namespace extension is made public or communicated to other endpoints, a subscriber may be able to retrieve or process information in a feed document that conforms to the namespace extension in ways that may not have been possible without the namespace extension.

Furthermore, with other types of documents, the use of a variety of formats for defining the schema, or data organization, of a document may be in use. For example, documents that use such formats may include document type definitions (DTDs) and XML Schema documents. Using a DTD or XML Schema document, an entity may in some cases be able to determine, for example, where particular data is located in a given document, the data type of particular data in a document, and so on.

### SUMMARY

The following presents a simplified summary of the disclosure in order to provide a basic understanding to the reader. This summary is not an extensive overview of the disclosure and does not identify key or critical elements of the invention or delineate the scope of the invention. Its sole purpose is to present some concepts disclosed herein in a simplified form as a prelude to the more detailed description that is presented later.

Described herein are various techniques and technologies directed to the definition and use of schema information with a document, including with a feed document. In some implementations, such schema information may be provided as part of the same document that contains the information to which the schema applies. Such schema information may be used in a variety of ways, including, for example and without limitation, to generate user interfaces that may display or enable editing of the information, to provide programmatic access to the information, to validate information, and so on.

### DESCRIPTION OF THE DRAWINGS

FIG. 1 illustrates an exemplary system in which documents that may contain or use schema information may be exchanged and used.

FIG. 2 illustrates an exemplary system that includes a graphical example of a document.

FIG. 3 illustrates an exemplary generalized operational flow including various operations that may be performed when creating, modifying, or using a document that includes a schema definition.

FIG. 4 illustrates an exemplary generalized operational flow including various operations that may be performed as part of modifying schema information associated with a document.

FIG. 5 illustrates an exemplary computer device in which the various technologies described herein may be implemented.

### DETAILED DESCRIPTION

Described herein are various techniques and technologies directed to the definition and use of schema information with a document, including with a feed document. More particularly, in at least some implementations, schema information may be provided as part of the same document that contains the information to which the schema applies. Such schema information may be used in a variety of ways, including, for example and without limitation, to generate user interfaces that may display or enable editing of the information, to provide programmatic access to the information, to validate information, and so on.

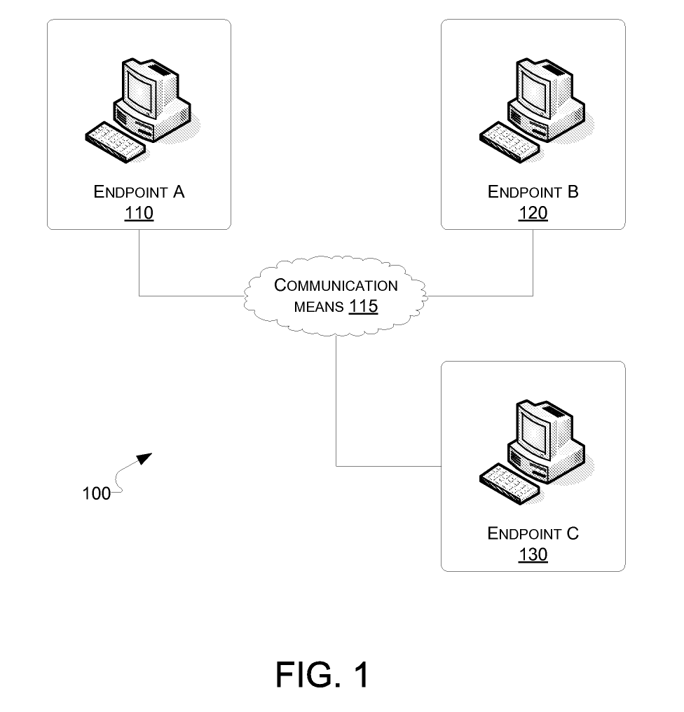

Turning now to FIG. 1, shown therein is an exemplary system 100 in which documents that may contain or use schema information may be exchanged and used. The exemplary system 100 contains endpoint A 110, endpoint B 120, endpoint C 130, and a communications means 115. Each of the endpoints in this example might represent one or more general-purpose or dedicated computer systems, including server computers, desktop computers, laptop computers, workstation computers, mobile or cellular telephones, personal digital assistants (PDAs), and the like. This description of FIG. 1 may be made with reference to other figures. However, it should be understood that the elements described with reference to FIG. 1 are not intended to be limited to being used with the elements described with reference to other figures. In addition, while the exemplary diagram in FIG. 1 indicates particular elements, in some implementations not all of these elements may exist, and in some implementations additional elements may exist.

In an example that may not use at least some of the techniques described herein, an endpoint may make information available to one or more other endpoints by publishing or making available a feed of information. In just one example, endpoint A 110 might generate an RSS feed that contains, say, references to audio and video data. The RSS feed in this example might be embodied in an XML file or data stream that contains at least some elements that conform to the RSS specification or standard. Endpoint A might then publish or make the generated feed available to other endpoints by, for example, placing the XML file that embodies the feed in a publicly-accessible directory on a web server. Then, a variety of other endpoints, including, say, endpoint B 120, may retrieve the RSS feed using a client such as an RSS aggregator or web browser that issues, say, an Hypertext Transport Protocol (HTTP) GET request to a uniform resource locator (URL) associated with the RSS feed. Such other endpoints may be considered to subscribe to the feed by retrieving it a single time; the same other endpoints may also retrieve the feed again one or more additional times for example, to stay aware of changes published by endpoint A.

It should be noted that while in this specific example the information is described as being made available using RSS and XML, that RSS and XML are not required and in the same or other implementations a wide variety of other feed and data-representation formats or standards may be used. Furthermore, regardless of the feed and data-representation format, any of a wide variety of data—not just references to audio and video data—may be distributed by an endpoint. Furthermore, the endpoints may communicate using a wide variety of networking and other communication methods, not just HTTP.

While in the previous example one endpoint published information and one more other endpoints subscribed to the information, in at least some other implementations, multiple endpoints may modify or change parts of the same set of information and such changes and possibly the data itself may be synchronized between endpoints. One such mechanism for implementing such synchronization may use “Simple Sharing Extensions” (SSE). For example, in some implementations, including those that use SSE, synchronization of data may be implemented, at least in part, by the addition of particular data to a feed of data provided using a possibly widely accepted protocol like RSS or Atom. For example, in an exemplary implementation with a topology that consists of only two endpoints that communicate with each other, one endpoint might publish an RSS feed that contains some type or types of information. In perhaps the same or another example, the feed might include calendar item information represented using a format like iCal or hCalendar, or some other format. As is common with feed protocols like RSS, and similar to the example provided previously (but with different exemplary synchronized information) the other endpoint might subscribe to the feed provided by the first endpoint and be notified when, for example, the first endpoint adds a new calendar item or changes an existing calendar item. However, in addition, and to synchronize data back to the original publisher in this example, a subscribing endpoint might publish its own feed, with the same data as is provided in the original publisher's feed and also with changes or additions made by the subscriber. The original publisher might then subscribe to this second feed. Through these mutual subscriptions, changes made by either endpoint may be reflected in the data maintained by both endpoints, enabling bi-directional synchronization. Multiple endpoints may participate and share the data by subscribing to at least one of the feeds provided by another endpoint and similarly publishing their own feed. When multiple endpoints subscribe and publish information using a synchronization system like SSE they may in some cases form a “sharing mesh” or “mesh” of endpoints, such that changes made by one endpoint may be transmitted—sometimes in a peer-to-peer fashion—to and between other endpoints, and thereby be propagated throughout the mesh.

In a variety of cases, including in implementations where multiple endpoints may modify the same feed—for example, as described above—it may be useful for the endpoints to be able to process the information in the feed by having some knowledge of the feed itself, including perhaps some or all of knowledge of how the information in the feed is organized, knowledge about the data types of the information in the feed, knowledge about whether particular pieces of the information in the feed are required, and so on. For example, if an RSS feed uses only the standard RSS elements, such as “title” and “description”, multiple endpoints may already understand the format of the feed document and so may be able to interpret the information in feed documents generated by other endpoints as well as generate feed documents of their own that are organized in the same way.

However, a feed document may also use a variety of additional elements that may not be part of the basic set of elements used by feed documents that conform to the same organization or format. For example, in some cases an RSS feed document might use elements that are not part of the basic or core RSS specification. Such elements may in some cases be defined or used through an extensibility mechanism, such as RSS namespace extensions. Furthermore, even with the use of only basic or standard elements, certain endpoints may have additional needs—for example, a set of endpoints might always require that the data in the “title” or “description” element is formatted in a certain way, contains data of a certain type, and so on.

Information about the organization of a feed may be distributed in a wide variety of ways. For example, a developer or user associated with one of the endpoints and with, say, the creation of the feed, might place telephone calls to developers or users associated with other endpoints and explain how the feed is organized. In the same or other cases, the creator of the feed might distribute this information to other endpoints via, say, an email message. The information about the feed that is distributed to endpoints might take a variety of forms. For example, if the feed itself is represented using XML, one might distribute information about the feed using a standard mechanism for describing the schema of an XML document, such as a DTD or XML Schema document. If the feed document uses a format like RSS, one might define additional elements to be included in the feed document using an extension mechanism like RSS namespace extensions.

While some of these solutions may provide for at least part of the information that might be preferably available to endpoints that want to subscribe to and/or publish feeds, these solutions may also have a variety of problems that may make their use less than ideal, at least in certain situations. For example, both DTDs and XML Schema documents may be relatively “heavyweight,” in that DTDs or XML Schema documents may contain a wide variety of information, at least some of which may in some cases not be necessary to simply exchange information using feeds. Similarly, interpreting and applying information from a DTD or XML Schema document may require a relatively large amount of executable code, in part due to the possible complexity of a DTD or XML Schema document. Depending on how an endpoint is implemented, such functionality may not already be included because it may not have been necessary simply to, for example, retrieve information from a feed document that follows a standard and relatively static format.

In the case of something like a namespace extension, like an RSS namespace extension, information about the organization of a feed document may typically be provided in human-readable text format so that a developer may, for example, be able to gain some understanding of how additional elements might be used in a feed that purports to conform to a particular namespace extension. For example, the creator a namespace extension might publish a human-readable specification for the namespace extension as, say, a PDF (portable document format) or word processing document and intend that the developers associated with endpoints that may want to interpret and use the information in a feed will read the specification and write executable code for their applications appropriately. However, while the information in such a specification or document may be suitable in some implementations for limited consumption of feeds, it may not typically provide enough information to enable other endpoints to generate conforming feeds themselves. In addition, the information in something like an RSS namespace extension may not be provided in a machine-readable format so that it may be programmatically interpreted by an endpoint without the direct human involvement.

Another characteristic of existing solutions for defining schema information may be that the schema information is provided in a separate location, document, or so on, from the information that conforms to the schema. For example, an XML document might conform to a particular schema, and might indicate conformance by referring to a separate XML Schema document that actually defines the schema. While such an organization may have advantages—such as reducing duplication of XML schema data when multiple documents use the same schema—in the same or other cases it may cause potential issues. For example, in some implementations it may be difficult to ensure that endpoints can access a separate representation of schema information, or to ensure that different endpoints are using the same instance of the schema information. Just one example of such a problematic implementation might be one in which endpoints exist on different networks that may only communicate in limited ways, such as might be the case when endpoints on different networks are connected in a mesh using one or more communication means that are limited in some fashion or fashions. For example, suppose that endpoint A 110 and endpoint B 120 are part of a local network, and may connect and exchange information with each other, but may not, for example, access a wider or larger network, such as the Internet. In such an environment, it might be possible to place a separate schema definition document on the local network in such a way that it is accessible to both endpoint A and endpoint B (however, this may still not ensure that both endpoints always use an up to date instance of the schema definition document). However, suppose that endpoint C 130 also shares and synchronizes information with endpoint A and endpoint B, and that endpoint C is not located on the local network. Instead, endpoint C might be located on some other network and might perhaps only have the capability of exchanging feeds with endpoint A or endpoint B. In such an environment, endpoint C may not be able to retrieve or access the schema definition document located on the local network. However, if the schema information is communicated as part of the same feed to which endpoint C already has access, endpoint C might then be able to use the same schema information that is used by endpoint A and endpoint B.

Generally, when shared data—like schema information—is represented in different locations, documents, and so on, ensuring that endpoints use the same and correct version of shared data can be a difficult problem. This may especially be the case in environments such as those that use communication topologies, like mesh networks, that may not always rely on centralized servers or endpoints. In these or other environments, communicating the schema information with a feed may in some cases at least make it possible for different endpoints to use the correct or same version of the schema information. That is, if a feed document includes schema information it may be more difficult for a processing endpoint to, say, incorrectly use a version of the schema information that is out-of-date or meant to be used with different feed document information.

In general, many of the issues that may be solved by the inclusion of relatively simple schema information a feed document may not have been previously recognized because feed documents have not typically been both subscribed to and published by multiple endpoints. Instead, it has been more common for a relatively small number of endpoints to define the schema and publish information that conforms to that schema. In such cases, subscribing endpoints may then interpret the information as they deem appropriate. When a subscriber doesn't interpret all of the information, or interprets at least some of the information “incorrectly”—for example, in a manner in which the publisher did not foresee or intend—only users of the subscriber's interpretation may be affected (or may not even be affected, if the users are, say, only interested in a subset of the data provided by a subscriber). However, when a subscriber also becomes a publisher of information—as they may be in a variety of synchronization scenarios, including those that operate with a mesh of endpoints that both subscribe and publish—it becomes much more important for endpoints to interpret information in a feed in the same way, and at least some of the technologies and techniques described herein become accordingly more useful.

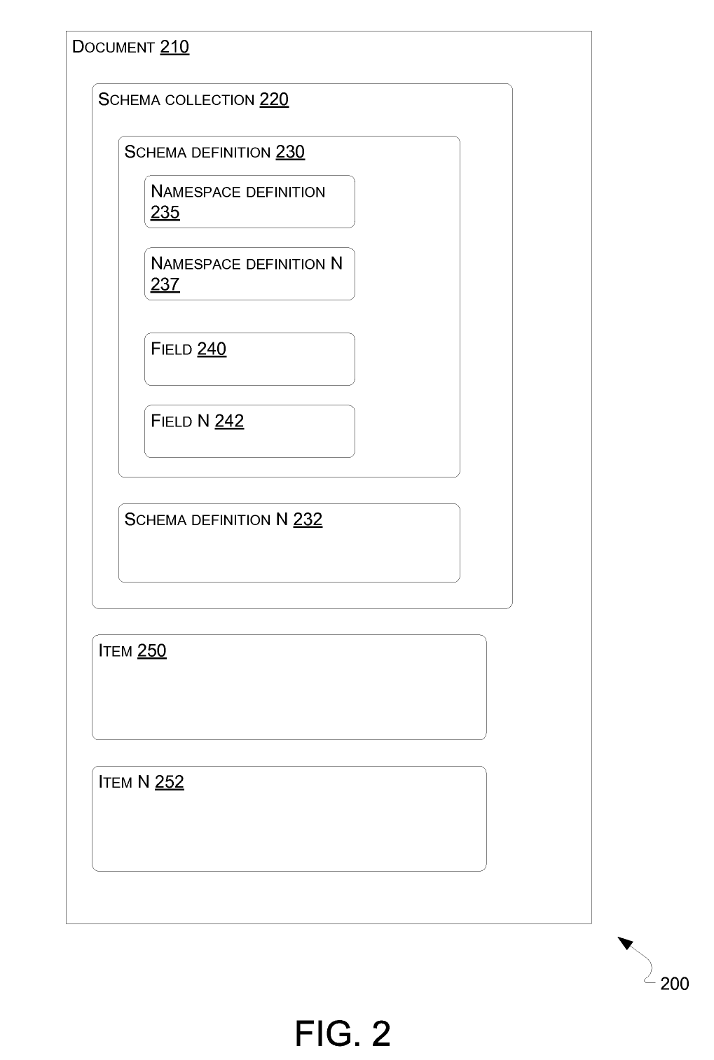

Turning now to FIG. 2, shown therein is an exemplary system 200 that includes a graphical example of a document 210. A document might comprise a schema collection 220, as well as some number of schema definitions, including the schema definition 230 and the schema definition N 232. An exemplary schema definition 230 might comprise a namespace definition 235 and a namespace definition N 237, as well as a field 240 and another field N 242. In addition, the document is also shown as comprising an item 250 and an item N 252. This description of FIG. 2 may be made with reference to other figures. However, it should be understood that the elements described with reference to FIG. 2 are not intended to be limited to being used with the elements described with reference to other figures. In addition, while the exemplary diagram in FIG. 2 indicates particular elements, in some implementations not all of these elements may exist, and in some implementations additional elements may exist.

A document, including a feed document, may be represented using any of a wide variety of formats. Generally, however, a document might contain information necessary to communicate item data and schema information, where item data might be data associated with the particular items being shared as part of a feed and the schema information might be additional data that provides information about the organization or schema of the document itself. Endpoints, including both publishers and subscribers, may be able to use schema information included in a document to understand the structure and properties of items in the document, and to, at least in some implementations, create new items or update existing items. In some implementations, a document might use a syndication or data sharing format, such as RSS or Atom, while in other implementations, a document may use a variety of other formats, including formats that do not use XML.

Regardless of the format used by the document, an exemplary document 210 may in some cases contain information about one or more schemas, such as the exemplary schemas collection 220. The schema information might be in some cases represented using XML elements, such as some of the exemplary elements described herein. While this data may be described with reference to XML elements, XML attributes, RSS, and so on, the use of XML or RSS is not required. Schema information, or the entire contents of a document for that matter, may contain some or all of this data and may represent the data in a variety of formats. For example, a schema collection represented using RSS and XML might comprise a “schemas” element that has, in some implementations, child “schema” elements. However, such a representation—using RSS, XML elements, XML attributes, and so on—is provided for exemplary purposes only. The data represented in such an example may also be represented in any of a wide number of alternate formats. Furthermore, while in this exemplary figure schema information and item information are shown in the same document, in some implementations schema information and item information may be located in different documents.

As just one example, schema information might be provided using an organization that is the same as or similar to the following example, where at least some particular parts of the example might be replaced when the example is used in a document:

```
<nid:schemas version=“version” defaultschemaid=“id”>
  <nid:schema id=“id” name=“name” titlefieldid=“id”
        descriptionfieldid=“id” deleted=“true | false”>
    <nid:namespace localprefix=“localprefix” uri=“uri” deleted=“true |
    false” />
    <nid:field
      id=“id”
      element=“element”
      label=“label”
      contenttype=“contenttype”
      type=“type”
      defaultvalue=“defaultvalue”
      array=“true | false”
      required=“true | false”
      hidden=“true | false”
      deleted=“true | false” />
  </nid:schema>
</nid:schemas>
```

With such an example, in at least some implementations, the schema collection 220 might correspond to the “schemas” or “nid:schemas” element. In some implementations, there may be zero or one “schemas” elements in a document. If the document includes a “schemas” element, the “schemas” element may have one or more child “schema” or “nid:schema” sub-elements and each “schema” element may correspond to one schema definition, including the exemplary schema definition 230 and the exemplary schema definition N 232. In some implementations, a schema definition—perhaps represented by a “schema” element—might include zero or more child “namespace” or “nid:namespace” sub-elements, which may correspond to the exemplary namespace definition 235 and the exemplary namespace definition N 237. Also, in some implementations, a “schema” element may include one or more child “field” or “nid:field” sub-elements, which may correspond to the exemplary field 240 and the exemplary field N 242. In some cases, in turn, each field may reference some property or element of an item, such as properties or elements of the exemplary item 250 or the exemplary item 252. Where items are represented using a format like XML, a property may be represented in multiple ways, including through the use of an XML element. In some implementations, some fields may reference particular namespace definitions, like perhaps namespace definition 235 and namespace definition N 237. (The “nid” prefix may be used in some cases, for example, to qualify the elements used to provide schema information, as explained in more detail below. In some cases the elements may also be referred to without a schema prefix—for example, as “schemas”, “schema”, “namespace”, “field”, and so on.)

A “schemas” element, which might represent a schema collection 220, may in some implementations include attributes such as “version” and “defaultschemaid”. A version attribute might represent some kind of version identifier, such as a number, that might be associated with the version of the schema information used in a particular document. In some cases, a “defaultschemaid” attribute, or the like, may be a unique value that represents an identifier of a schema definition to use if no “schema” sub-element exists for an item.

As introduced previously, a schema collection such as the schema collection 220, may in turn include some number of schema definitions, such as the schema definition 230 and the schema definition N 232. In some implementations, each schema definition may be represented using an XML element like the previously introduced “schema” element.

In some implementations, each schema definition may include at least some attributes that define characteristics of the schema definition. At least some of such attributes may be explained in more detail in the following paragraphs. Note that not all of the attributes explained in the following paragraphs may be required or included in any particular implementation, and in some implementations additional attributes may be present.

In some implementations, a schema definition might include an attribute like “id”, which might be a unique value that represents the schema definition. In some cases this attribute may be used, for example, to enable other parts of the document or schema definition to refer to a particular schema definition, or may be used for other purposes. In some implementations, this value may be required.

In the same or other implementations, a schema definition might include a “name” attribute, or the like, which might provide, for example, a human-readable name for the schema definition.

In the same or other implementations, a schema definition might include attributes like “titlefieldid” or “descriptionfieldid”. An instance of one of these attributes might include an identifier that corresponds to, for example, a field in a schema definition, such as the field 240 or the field N 242. If the attribute is set, the value of the identifier might be used to retrieve the value of the element to which the field refers, and this value may then be used to set the “title” or “description” field of the item, for example. While this concept might be applied to the “title” and “description” elements because such elements are used in RSS feeds, the same concept or process may also be applied to other elements of an item. In some cases if one of these attributes is not included in the schema definition, there may be no mapping for the corresponding element including, say, “title” or “description”.

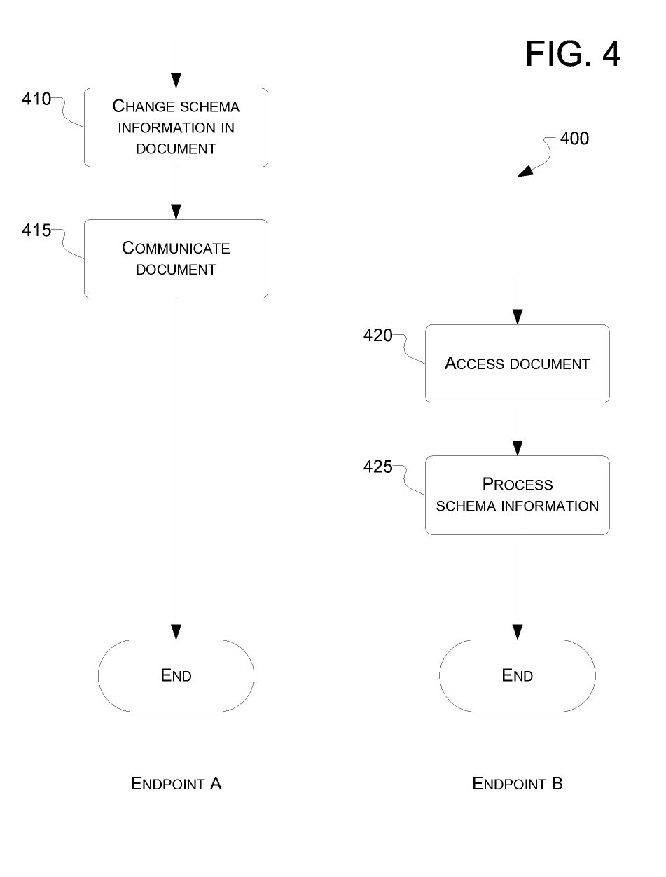

In some implementations, a schema definition might include an attribute like “deleted”. In at least some of such implementations, if a “deleted” attribute exists and has a value such as “true”, the schema definition may no longer be used or be valid for particular operations, including perhaps to create new items or to edit existing items. If the “deleted” attribute does not exist or exists but has a value such as “false”, the schema definition may in some cases be used or be valid for particular operations, including perhaps for creating new items or editing existing items. Some examples of behaviors that may be used when updating schema definitions, including the use of a “deleted” attribute, are explained in more detail below with reference to FIG. 4.

In some implementations, a schema definition like the schema definition 230 or the schema definition N 232 may itself comprise some number of namespace definitions, such as the namespace definition 235 and the namespace definition N 237. In some implementations, each namespace definition may be represented using an XML element like the previously introduced “namespace” element. In some implementations, some fields—discussed below in more detail—may reference a namespace definition to indicate that the element to which the field refers is associated with or uses the particular referenced namespace definition.

In some implementations, each namespace definition may include at least some attributes that define characteristics of the namespace definition. At least some of such attributes may be explained in more detail in the following paragraphs. Note that not all of the attributes explained in the following paragraphs may be required or included in any particular implementation, and in some implementations additional attributes may be present.

In some implementations, a namespace definition might include an attribute like “localprefix”, which might be associated with a value that identifies the namespace definition in the document. In some cases this attribute may be used, for example, to enable other parts of the document or schema definition, such as individual fields, to refer to a particular namespace definition. In some implementations, this value may be required. As just one example—also discussed in more detail below—if a “localprefix” value of a particular namespace definition is something like “geo”, a field might indicate that it is associated with that namespace definition by using the “geo” prefix as part of the field's “element” attribute.

In the same or other implementations, a namespace definition might include an attribute like “uri”, which might have as a value a namespace uniform resource identifier (URI) that identifies a particular namespace. While an attribute like “uri” may reference any URI, in at least one example, it might have a value such as “http://www.w3.org/2003/01/geo/wgs84_pos#”, which might refer to a “Basic Geo” namespace for representing location information such as latitude and longitude. In other examples and implementations, the “uri” value may be different.

In at least some implementations, a namespace definition might include an attribute like “deleted”. In at least some of such implementations, if a “deleted” attribute exists and has a value such as “true”, the namespace definition may no longer be used or be valid for particular operations, including, perhaps to create new items or to edit existing items. If the “deleted” attribute does not exist or has a value such as “false”, the namespace definition may be valid for use for some operations, including perhaps when creating new items or editing existing items. Some examples of behaviors that may be used when updating namespace definitions, including the use of a “deleted” attribute, are explained below with reference to FIG. 4.

In some implementations, a schema definition like the schema definition 230 or the schema definition N 232 may comprise some number of fields, such as the field 240 and the field N 242. In some implementations, each field may be represented using an XML element like the previously introduced “field” element.

In some implementations, each field may include at least some attributes that define characteristics of the field definition. At least some of such attributes may be explained in more detail in the following paragraphs. Note that not all of the attributes explained in the following paragraphs may be required or included in any particular implementation, and in some implementations additional attributes may be present.

In some implementations, a field might include an attribute like “id”, which might be a unique value that represents the field. In some cases this attribute may be used, for example, to enable other parts of the document or schema definition—such as perhaps the previously introduced “titlefieldid” or “descriptionfieldid” attributes—to refer to a particular field. In some implementations, this value may be required. Note that in some implementations the value may be unique, but only in a particular scope. For example, the value may be unique among fields of a particular schema definition, but might have the same value as some other field in another schema definition. In such an example, a field may still be uniquely identified within the entire document by, for example, a combination of the schema definition's unique identifier and the field's unique identifier.

In some of the same or other implementations, a field might include an attribute like “element”. In some implementations, the value associated with this attribute might be the name of an element that is a child of or otherwise associated with an item, and perhaps accessible using an “item” element. That is, this field might be used in some implementations to reference or link a field with part of an item. In so doing, the information provided with the field—like one more data types, a label, and so on—may be used to interpret, set, manipulate, or otherwise operate on the referenced or linked item. The value associated with an “element” field might in some implementations also provide information that may reference or identify namespace information, such as a namespace definition that is the same as or similar to the previously described namespace definitions, like the namespace definition 235 or the namespace definition N 237. As just one non-limiting example that will also be described in more detail below, suppose that the value associated with an “element” attribute is something like “geo:lat”. In some implementations, a value such as this might indicate that the information associated with this field may be used with sub-elements of an “item” (or other) element named “lat” (and that may use the “geo” prefix, so may be referred to as “geo:lat” elements). In some case, such a value may also indicate that a namespace definition with a “localprefix” value of “geo” may be associated with this field or with associated item elements.

In some cases, an attribute like “element” may contain one or more instances of a delimiter character or text—perhaps like “/” or “\”—that may in some cases indicate that the referenced element is located in some type of hierarchy beneath, for example, a base “item” element. Furthermore, the same or other delimiter text may have additional meaning when used with an attribute like the “array” attribute, which is described in more detail below. In some implementations, this value may be required.

In some implementations where a namespace is not referenced or identified, the associated element may be assumed to not have a namespace. For example, the RSS “title” and “description” elements may not have a defined namespace, and so when a field references one of these attributes, the field may in some cases at least not identify a namespace.

Some implementations may include a “label” attribute as part of a field. In at least some of such implementations, the value of an attribute like “label” might contain a human-readable name for the referenced element. In some implementations, including when this attribute is not specified, an endpoint that processes the document may use another value or element as a label. For example, an endpoint might instead use the value of the “element” attribute as the human-readable name.

In some implementations, a data type of the value associated with the referenced element may be indicated through the use of one or more field attributes, including, perhaps, “contenttype” and “type”. For example, possible values for a “contenttype” attribute might be values such as “text”, “text/xml”, “text/html”, “application/xhtml+xml”, and so on. In at least some implementations, if a data type is not provided, a default, like “text”, may be assumed.

While it may be possible and useful to specify that the element referenced by a field contains a value that uses a data type like text, and so on, it may also be useful to specify that the data type of an element may be any of a particular or specific type of data. For example, information about an event might be stored using a format like iCal or hCalendar. In another example, an object—including objects associated with programming languages and environments, like, say, a .NET, Java, or Ruby object—may be serialized to some format, such as XML, and then the serialized data may be stored as the value of the element.

An additional attribute, perhaps called “type”, might be used, for example, if the value of an attribute such as “contenttype” is not sufficient to completely determine the type of the data stored in the value of a referenced element, or for other reasons. Such an attribute might have a variety of possible values, including “datetime”, “boolean”, “number”, “floatingpoint”, and other possible values. For example, when the “contenttype” attribute has a value such as “application/xhtml+xml”, additional information may be necessary to determine the format of the data. For example, in this case, the “type” attribute might have a value of “vevent”, which might indicate that the data is formatted using the hCalendar standard. In the example where a serialized representation of an object is stored in the referenced element, the “type” attribute may in some cases contain some type of value that enables or aids an endpoint in working with the object, including in deserializing the object from its stored representation so that the object may be reconstituted and used, for example, in a particular programming or object environment. For example, in such a case, the “type” attribute might contain a value such as “urn:MyObjectType”, where “MyObjectType” is the type of the serialized object.

In some implementations, a field might include an attribute such as “defaultvalue”. Such an attribute, if provided, might contain a default value available for use with the element to which the field refers.

In at least some implementations, a field might also include an attribute such as “array”. If set to a value such as “true”, this attribute might indicate that the element to which the associated field refers is actually a collection of perhaps multiple values. In some cases, such values may be provided as child elements of the at least one of the elements identified in the field's element reference. For example, the last element identified in the element reference—perhaps using the “element” attribute—may be considered in some cases to contain the name of each child item in the collection. In some implementations, if an attribute like this is not provided, it may be assumed to default to “false”.

In some implementations, a field might include an attribute such as “required”. This attribute might indicate that the associated element must have a value, or must have a value that is valid according to other criteria like the data type of the element, and so on. In at least some implementations, if an attribute like this is not specified, a default required value, like “false” or “true”, may be assumed.

Some implementations might also include a field attribute such as “hidden”. In at least some of such implementations, if a “hidden” attribute has a value such as “true”, it may indicate to endpoints that operate on the associated element that the element should not be displayed by, for example, a user interface that might display the item.

Finally, in some implementations, a field might include an attribute like “deleted”. In at least some of such implementations, if a “deleted” attribute exists and has a value such as “true”, the field may no longer be used or be valid for particular operations, including, perhaps to create new items or to edit existing items. If the “deleted” attribute does not exist or has a value such as “false”, the field may be valid for use for some operations, including perhaps when creating new items or editing existing items. Some examples of behaviors that may be used when updating fields, including the use of a “deleted” attribute, are explained below with reference to FIG. 4.

As just one example, a feed document with schema information might be represented in a manner the same as or similar to the following document:

```
<rss version=“2.0”
        xmlns:nid=“http://www.microsoft.com/schemas/nid”
        xmlns:csacd_contact=“http://www.microsoft.com/schemas/csacd/contact”
        xmlns:geo=“http://www.w3.org/2003/01/geo/wgs84_pos#”>
  <channel>
    <title>Contacts</title>
    <description>Sample list of contacts</description>
    <nid:schemas version=“0.88”
            defaultschemaid=“urn:microsoft.com/schemas/nid/contactwithgeo”>
      <nid:schema id=“urn:microsoft.com/schemas/nid/contactwithgeo”
            name=“Contact with Geo”
            titlefieldid=“01” descriptionfieldid=“03”>
        <nid:namespace localprefix=“csacd_contact”
              uri=“http://www.microsoft.com/schemas/csacd/contact”/>
        <nid:namespace localprefix=“geo”
            uri=“http://www.w3.org/2003/01/geo/wgs84_pos#”/>
        <nid:field id=“01” element=“csacd_contact:fn” required=“true”
          contenttype=“text” label=“Full Name”/>
        <nid:field id=“02” element=“csacd_contact:Created” label=“Created”
          deleted=“true”/>
        <nid:field id=“03” element=“csacd_contact:info” label=“Comments”/>
        <nid:field id=“04” element=“geo:lat” lable=“Lattitude”
          type=“double” defaultvalue=“0.0”/>
        <nid:field id=“05” element=“geo:long” label=“Lattitude”
          type=“double” defaultvalue=“0.0”/>
        <nid:field id=“06” element=“csacd_contact:Addresses\csacd_contact:Address”
          label=“Addresses” array=“true”/>
        <nid:field id=“07” element=“csacd_contact:Created2” label=“Created”
          required=“true” type=“date”/>
      </nid:schema>
    </nid:schemas>
    <item>
      <title>John Doe</title>
      <description>Developer</description>
      <nid:schema id=“urn:microsoft.com/schemas/nid/contactwithgeo”/>
      <csacd_contact:fn>John Doe</csacd_contact:fn>
      <csacd_contact:Created>2006-09-22T21:27:24Z</csacd_contact:Created>
      <csacd_contact:info>Developer</csacd_contact:info>
      <geo:lat>42.322</geo:lat>
      <geo:long>22.11</geo:long>
      <csacd_contact:Addresses>
        <csacd_contact:Address>1 Redmond Way, Redmond, WA 98052</csacd_contact:Address>
      </csacd_contact:Addresses>
    </item>
    <item>
      <title>Jack Doe</title>
      <description>Program Manager</description>
      <nid:schema id=“urn:microsoft.com/schemas/nid/contactwithgeo”/>
      <csacd_contact:fn>Jack Doe</csacd_contact:fn>
      <csacd_contact:Created>2006-09-22T21:27:24Z</csacd_contact:Created>
    </item>
  </channel>
</rss>
```

This exemplary document contains a schema collection 220, represented by the “nid:schemas” element. While schema information may be used in any type of a document, this example shows one manner in which it might be used with an RSS document, hence the presence of standard RSS elements such as “rss”, “channel”, “item”, “title”, and “description”.

Although some documents may contain multiple schema definitions in a single schema collection, this exemplary document shows only a single schema definition 230, represented by the “nid:schema” element. This schema contains seven exemplary fields, which might correspond to the field 240 and the field N 242, and are in this example represented by “nid:field” elements. This schema also contains two exemplary namespace definitions, which might correspond to the namespace definition 235 and the namespace definition 237, and are in this example represented by “nid:namespace” elements.

The “schemas” element in this exemplary document, again corresponding perhaps to the schema collection 220, is as follows (note that the complete document also contains a closing tag for this element and other elements described below):

<nid:schemas version=“0.88”
defaultschemaid=“urn:microsoft.com/schemas/nid/cantactwithgeo”>

In this example, the “schemas” element serves as a container for a child “schema” element, discussed below. It also uses the “defaultschemaid” attribute to identify a particular schema definition—in this case the only schema definition in the collection—as the schema definition to use for any items in the document that may not specify a particular schema definition. (In this example document, both of the exemplary items specify the schema definition explicitly, so this attribute might not currently be used when the document is processed, at least to associate a schema definition with an item.)

The “schema” element in this exemplary document, perhaps corresponding to a single schema definition 230, is as follows:

```
<nid:schema id=“urn:microsoft.com/schemas/nid/contactwithgeo”
    name=“Contact with Geo”
    titlefieldid=“01” descriptionfieldid=“03”>
```

This exemplary “schema” element serves as a container for a number of exemplary namespace definitions and fields. It also specifies an identifier for the schema definition (the same identifier used, in this example, in the “defaultschemaid” attribute discussed previously). The “titlefieldid” and “descriptionfieldid” attributes specify that the fields with the identifiers of “01 ” and “03”, respectively, may correspond to the RSS “title” and “description” elements. In this case, this results in the “csacd_contact:fn” element corresponding to the “title” element and the “csacd_contact:info” element corresponding to the “description” element.

The schema definition includes multiple fields, which might correspond to the field 240 and the field N 242. Some particular fields that may show particular features of the schema information are discussed in some of the subsequent paragraphs (not all of the field elements are discussed in detail).

As one example, the first “nid:field” element is as follows:

<nid:field id=“01” element=“csacd_contact:fn” required=“true”
contenttype=“text” label=“Full Name”/>

This field provides schema information for a particular part of each item element. In this example, the “element” attribute has a value of “csacd_contact:fn”. This value links this field element to a particular element in each of the items in the document. In this example, the first of the two referenced elements is:

<csacd_contact:fn>John Doe</csacd_contact:fn>

The second referenced element is:

<csacd_contact:fn>Jack Doe</csacd_contact:fn>

As the field element references these sub-elements of the “item” element, an endpoint that is processing this document may use information it retrieves from the field element when processing the “csacd_contact:fn” element of each item. As just one specific example, as the field specifies the label “Full Name”, an endpoint that is programmatically or dynamically generating, say, a user interface to display or enable editing of this information might display “John Doe” or “Jack Doe” next to the label “Full Name”.

Furthermore, as the field definition includes as part of the “element” attribute a prefix of “csacd_contact”, the field may in some implementations be considered to be associated with the namespace definition that has the “localprefix” value of “csacd_contact”. The namespace definition with the “localprefix” value of “csacd_contact” in this example is:

<nid:namespace localprefix=“csacd_contact”
uri=“http://www.microsoft.com/schemas/csacd/contact”/>

Since this field references this namespace definition, the “csacd_contact:fn” element for each item may be known to comply with the requirements of the “csacd_contact:fn” element defined by the “http://www.microsoft.com/schemas/csacd/contact” namespace.

The remainder of the “field” elements also include “element” attributes that reference particular elements of items in the document. Some of these fields demonstrate the use of, for example, different namespaces, as well as different field attributes, like “contenttype”, among other things.

Upon examination of the previously provided exemplary document, one may notice that the fields with identifiers of “02” and “07” reference similar “csacd_contact:Created” and “csacd_contact:Created2” elements, but have different specified type information. The field with the identifier of “02” also has a “deleted” attribute with a value of “true”. As will be discussed in more detail below, with reference to FIG. 4, these two fields may demonstrate one manner in which schema information may be changed and updated over time.

It should be noted that in some implementations, including those where schema collection and schema definition information may be included in an RSS document, the organization of schema collection and schema definition information itself may be specified using an extensibility mechanism like the previously introduced and discussed RSS namespace extension mechanism. In such an example, the schema collection, schema definition, and field elements themselves may have a namespace, such as “http://www.microsoft.com/schemas/nid”, and may have a prefix like “nid”.

Also, although at least some of the examples provided herein refer to elements with names such as “schema”, “schemas”, and so on, other names may also be used. For example, in some implementations, a schema might generally be referred to as a “binding” (perhaps because the information provides a kind of binding between a collection of fields or data and a representation that the fields or data might have, for example, in a user interface view or editor). In such implementations, and possibly in other implementations, the previously described “schemas” element might be referred to instead as, for example, a “bindings” element; the previously described “schema” element might be referred to instead as, for example, a “binding” element, and so on.

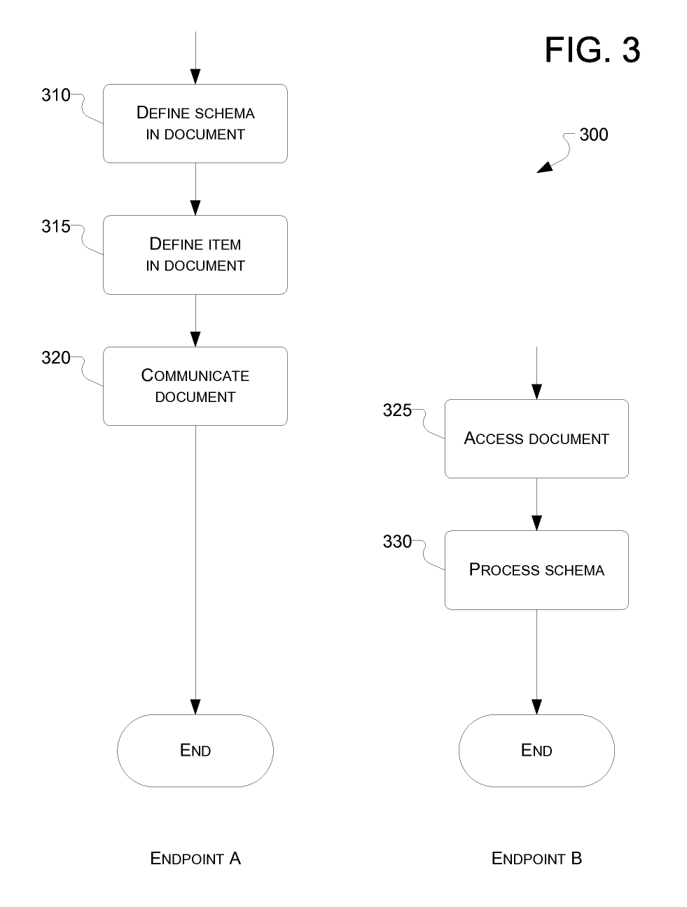

Turning now to FIG. 3, shown therein is an exemplary generalized operational flow 300 including various operations that may be performed when creating, modifying, or using a document that includes a schema definition. The following description of FIG. 3 may be made with reference to other figures. However, it should be understood that the operational flow described with reference to FIG. 3 is not intended to be limited to being used with the elements described with reference to these other figures. In addition, while the exemplary operational flow of FIG. 3 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

In an exemplary implementation of operation 310, executable code associated with an endpoint—perhaps an exemplary endpoint A—may define schema information in a document. Such definition may be performed in a variety of ways. As just one example, when the endpoint generates a feed document—like an RSS feed, perhaps—the endpoint may include schema information in the feed document. Such schema information may in some cases be the same as or similar to the schema information introduced and discussed previously, for example, with reference especially to FIG. 2. That is, in this example at least, the endpoint might include a schema collection, perhaps represented as a “schemas” element, that may comprise one or more schema definitions, perhaps represented as “schema” elements, that each in turn may comprise one or more fields, perhaps represented as “field” elements. In other examples, the definition of schema information may be different.

In at least one exemplary implementation of operation 315, an endpoint—including in some cases the same endpoint associated with operation 310 —may define one or more items in a document. Such item definition may be performed in a variety of ways, may be performed by a variety of executable code associated with different applications or purposes, and so on. In at least some implementations, items may be associated in some fashion with schema information. For example, in some implementations, one or more items like the items and “item” elements described previously with reference to FIG. 2 may be added.

While in this exemplary operational flow the define schema operation 310 is discussed before the define item operation 315, it should be noted again explicitly that the schema may not in all cases be defined or provided before items are defined. For example, in some cases, a document may first contain one or more items, and schema information may be added later. In other cases, schema and item information may be added at multiple various points in time, and so on.

In at least some exemplary implementations of operation 320, the document that might include schema information, items, or both schema information and items, may be communicated to some other endpoint or may be made generally available for communication or access by other endpoints. In just one example of this operation, the document may be communicated by being placed on a publicly accessible part of a web server, so that it is available to be downloaded by some other endpoint. In another example, the document may be affirmatively communicated to some other endpoint by being sent via email or some other communication mechanism to some other endpoint, and so on. In different implementations any of a variety of communication mechanisms may be used, so long as the document is communicated from the publishing endpoint to a subscribing endpoint.

In at least one exemplary implementation of operation 325, the document may be accessed by some endpoint. In at least some implementations, the endpoint that performs operation 325 may be different from the endpoint that performs, for example, the previous operations (as will be discussed in more detail below). For example, an exemplary “endpoint B” might implement or perform operation 325 as well as possibly operation 330, while the previously introduced and also exemplary endpoint A may perform some or all of, for example, operation 310, operation 315, and operation 320. In some implementations, at least part of the implementation of operation 325 may depend on how the document is communicated or made available, for example, in operation 320. For example, as part of some implementations of this operation, an endpoint may issue an HTTP request to a web server that makes available the document and receive the document in response to the request. In other implementations, the document may be accessed in other ways.

Finally, in at least some exemplary implementations of operation 330, the schema and possibly item information in the document may be used or processed by the endpoint in some fashion. The implementation of this operation may vary widely depending on characteristics such as, for example, the information comprised by the schema information in the document, the items in the document, the purpose or purposes of the endpoint, and so on. Generally, at least some implementations of this operation may involve parsing or interpreting the contents of the schema information in the document and performing additional processing using, at least, the retrieved schema information.

In one example, the processing may involve executing at least some executable code that is involved in generating or building a user interface, or that uses at least some of the schema information provided in the document. For example, this operation might dynamically generate a user interface that contains at least some fields associated with fields in a schema definition. In a specific example, executable code might iterate over the fields in a schema definition and generate a user interface element for each field, as long as the field does not contain information—such as a “hidden” attribute that is set to “true”—that indicates that the field might not be shown to users. A “data-driven” user interface such as a user interface generated by processing schema information may in some cases be changed solely by changing the schema information, which may be useful in many cases as it may remove the need, for example, for a developer to manually change code when the information managed by an application changes, as well as providing other benefits. In some cases, a user interface that is generated or that might already exist, might use schema information for additional purposes. For example, executable code associated with a user interface might validate that a user using the user interface has entered the correct type of data for a particular field, has entered data for required fields, and so on.

In another example, schema information might be used as part of generating an application programming interface (API) that enables users or developers to retrieve items, to retrieve information about items and the schema associated with items, and so on. As one specific example, an API might enable a developer to retrieve or set the value of an element that is referenced by part of the schema information in a document. For example, if a field in a schema definition references, say, an “item” element and a “fn” (perhaps “full name”) element that might be a child of the “item” element, such an API might enable a user or developer to retrieve or set a value associated with, say, the “fn” element. In the same or other implementations, the same or another API might make some or all of the information associated with a schema definition available to a user of the API. For example, a user of the API might be able to programmatically retrieve a data type, human-readable label, required value, and so on, that each might be associated with an element. The information provided by the API might be at least in part retrieved or associated with the schema information, including one or more fields.

In some cases the operations shown in the first column, and identified with endpoint A, including operation 310, operation 315, and operation 320, may be performed on one endpoint, while the operations identified with endpoint B in the second column, including operation 325 and operation 330, may be performed on some other endpoint. For example, one endpoint—perhaps in some implementations like the endpoint A 110 described previously with reference to FIG. 1—might execute some or all of operation 310, operation 315, or operation 320 and create a document that includes schema information and items. Another endpoint—like perhaps the endpoint B 120—might execute some or all of operation 325 and operation 330 to access the document and perform processing associated with the document. However, it should be noted that it is not required that two different endpoints perform the operations described with reference to FIG. 3. Instead, for example and without limitation, a single endpoint may perform some or all of the operations shown.

Turning now to FIG. 4, shown therein is an exemplary generalized operational flow 400 including various operations that may be performed as part of modifying schema information associated with a document. The following description of FIG. 4 may be made with reference to other figures. However, it should be understood that the operational flow described with reference to FIG. 4 is not intended to be limited to being used with the elements described with reference to these other figures. In addition, while the exemplary operational flow of FIG. 4 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

In many implementations of systems that use schema information it may be impossible, or at least difficult, to change or modify schema information, especially after the schema information has been in use for some period of time. In other implementations, such modification may be performed in a variety of manners and fashions. For example, in at least some relatively simple implementations, it may be possible for endpoints that receive documents that include changed schema information to perform one or more checking operations that do not consume much time—perhaps, for example, to see if the schema information in the document has been updated more recently than the schema of which they are aware—and then in some cases update their locally-maintained schema information using the newly received schema information. In other implementations, it may be possible to treat the schema as synchronized data itself and to make changes using a synchronization protocol or system that may be suitable for synchronizing a wide variety of information. In such implementations, for example, endpoints might use SSE to synchronize schema information. In yet other implementations, schema information may be transferred between endpoints using particular rules, such as some or all of the operations described below with reference to FIG. 4, especially.

In an exemplary implementation of operation 410, the schema associated with a document may be modified or updated, and the schema information in the document may also be modified so that it reflects the changes to the schema. The manner in which the schema information in the document may change may vary depending on a variety of characteristics including how the schema itself is changing, how the schema information is represented in a document, and so on. At least some of the examples described below may refer to the schema information as it was described previously, for example, with reference to FIG. 2. However, the changes associated with this operation or with this operational flow may be made in at least some implementations regardless of how the schema information is represented in the document. That is, for example, a “schemas” element, a “schema” element, and so on, may not be required while in other implementations at least the information associated with such elements may be represented in a variety of other fashions.

In one example, a new schema definition may be added to an existing schema collection in a document. For example, this might be accomplished by defining a new “schema” element with one or more child “field” elements. The new “schema” element might be defined as a child of a previously existing “schemas” element. Optionally, an attribute such as a schema collection's “defaultschemaid” attribute might be set to reference the new schema definition.

In another example, an existing schema definition might be deleted. Such an operation might be performed in some exemplary implementations by setting a “deleted” attribute to “true”, where the “deleted” attribute might be associated with an existing “schema” element. Optionally, an attribute such as a schema collection's “defaultschemaid” attribute might be set to reference some other schema definition. Note that in this example, and at least in some implementations, the information in the document associated with the deleted schema may remain in the document, but the schema may be considered to be “deleted” simply because it comprises information—like a “deleted” attribute set to “true”—that indicates that it is no longer valid and may in some cases no longer be used for particular operations, like to create new items or to edit or modify existing items.

In another example, a new namespace definition may be added to an existing schema definition in a document. For example, this might be implemented by defining a new “namespace” element that is a child of an existing “schema” element.

In yet another example, an existing namespace definition might be deleted. Such an operation might be performed in some exemplary implementations by setting a “deleted” attribute to “true”, where the “deleted” attribute might be associated with an existing “namespace” element. Similar to the previous explanation provided for deleted schema definitions, in at least in some implementations, the information in the document associated with the deleted namespace definition may remain in the document, but the field may be considered to be “deleted” simply because it comprises information—like a “deleted” attribute set to “true”—that indicates that it is no longer valid and may in some cases no longer be used when performing particular operations, like creating new items or editing or modifying existing items.

In another example, a new field may be added to an existing schema definition in a document. For example, this might be implemented by defining a new “field” element that is a child of an existing “schema” element.

In yet another example, an existing field might be deleted. Such an operation might be performed in some exemplary implementations by setting a “deleted” attribute to “true”, where the “deleted” attribute might be associated with an existing “field” element. Similar to the previous explanation provided for deleted schema definitions and namespace definitions, in at least in some implementations, the information in the document associated with the deleted field may remain in the document, but the field may be considered to be “deleted” simply because it comprises information—like a “deleted” attribute set to “true”—that indicates that it is no longer valid and may in some cases no longer be used when performing particular operations, like creating new items or editing or modifying existing items.

It should be noted that while the previous examples may have only described how to add and delete, for example, schema definitions, namespaces, and fields, that changes or modifications of existing information may also be implemented. As just one example, an existing field may be modified by “deleting” the existing field and “adding” a field, where the new field may be the same as the previous field except for the desired change or changes. As just one example, the exemplary document described previously with reference to FIG. 2 comprises two related fields, one that is associated with an element identified by the name “csacd_contact:Created” and one that is associated with an element identified by the name “csacd_contact:Created2”. The first of these fields has its “deleted” attribute set to true, while the second of these fields has a different specified data type than the first field (which did not have a data type specified explicitly) and is not marked as being deleted. Such an arrangement of fields might have been the result of a modification of this field by deleting the first field and adding the second field.

In at least some exemplary implementations of operation 415, the document that might include the schema changes may be communicated to some other endpoint or may be made generally available for communication or access by other endpoints. In just one example, and as was described previously with reference to FIG. 3, for example, the document might be communicated by being placed on a publicly accessible part of a web server, so that it is available to be downloaded by some other endpoint. In another example, the document may be affirmatively communicated to some other endpoint by being sent via email or some other communication mechanism to some other endpoint, and so on.

In at least one exemplary implementation of operation 420, the document may be accessed by some endpoint. In at least some implementations, the endpoint that performs operation 420 may be different from the endpoint that performs, for example, the previous operations (as will be discussed in more detail below). For example, an exemplary “endpoint B” might implement or perform operation 420 as well as possibly operation 425, while some other exemplary “endpoint A” may perform some or all of, for example, operation 410 and operation 415. At least part of this operation may in some implementations depend on how the document is communicated or made available, for example, in operation 415. For example, as part of some implementations of this operation, an endpoint may issue an HTTP request to a web server that makes available the document and receive the document in response to the request. In other implementations, the document may be accessed in other ways.

Finally, in at least some exemplary implementations of operation 425 an endpoint that accesses a document that includes schema changes may perform some processing using the changes. For example, an endpoint that uses schema information might maintain its own cache or store of such schema information to use, for example, as part of processing documents that use the schema. In such a case, the cached schema information may be updated in a variety of ways so that it is consistent with the schema information provided in a document.

For example, an endpoint might iterate through the schema definitions defined in a document—perhaps by examining each “schema” element—and determine that a new schema definition has been added when, for example, the “id” attribute of a schema definition in the document has not been previously seen or is not known by the endpoint.

In another example, an endpoint might iterate through the schema definitions defined in a document and determine that a schema definition has been deleted when a “deleted” attribute associated with the schema definition is set to “true”.

In another example, an endpoint might iterate through the namespace definitions in a document—perhaps by examining each “namespace” element—and determine that a new namespace definition has been added when, for example, the “uri” or “localprefix” attribute of a namespace definition in the document has not been previously seen or is not known by the endpoint.

In another example, an endpoint might iterate through the namespace definitions defined in a document and determine that a namespace definition has been deleted when a “deleted” attribute associated with the namespace definition is set to “true”.

In another example, an endpoint might iterate through the fields in a document—perhaps by examining each “field” element—and determine that a new field has been added when, for example, the “id” attribute of a field in the document has not been previously seen or is not known by the endpoint.

In yet another example, an endpoint might iterate through the fields defined in a document and determine that a field has been deleted when a “deleted” attribute associated with the field is set to “true”.

When a change has been identified, in at least some implementations, the endpoint may perform additional processing associated with the change. For example, an endpoint might update a cached or locally stored or associated copy of the schema information so that the cached information now reflects the updated schema information embodied in the document.

In some implementations, such processing as has been previously described may enable endpoints to make independent changes to schema information without “stepping on” or “overwriting” such changes. For example, a first endpoint might add a first new field to a schema definition and a second endpoint might add a second new field to the same schema definition. When the first endpoint processes the schema information from the second endpoint, it may incorporate the second new field, even though it has already modified the schema information to incorporate the first new field. Similarly, the second endpoint may incorporate the first new field when it processes the schema information, even though it has already modified the schema information to incorporate the second new field. After such schema processing, both endpoints might then have the same schema information, with both new fields. This behavior may be in contrast to at least some other exemplary implementations, not described herein, where independent changes to information may result in, say, only the most recent or last change being used by endpoints, which in this exemplary case might result in one of the field additions being ignored or “lost.”

### Example Computing Environment

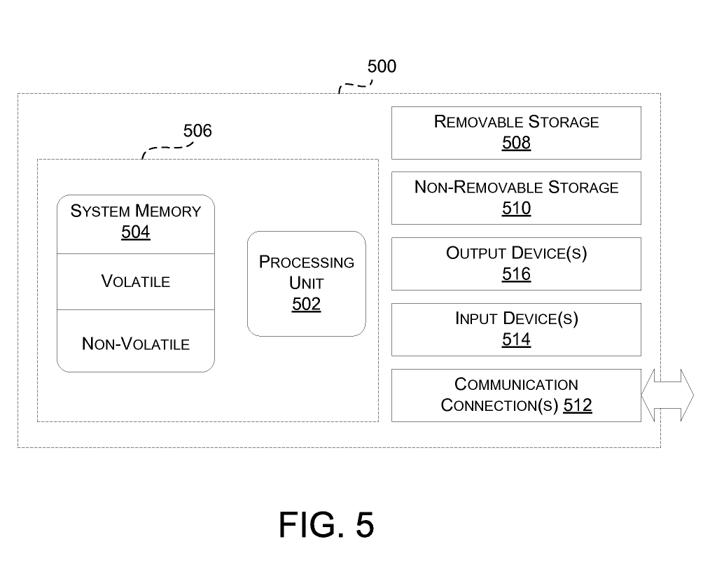

Turning now to FIG. 5, this figure and the related discussion are intended to provide a brief and general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 500 illustrated in FIG. 5.

Generally, program modules include routines, programs, objects, components, user interfaces, data structures, and so on, that perform particular tasks, display particular information, or implement particular abstract data types. Operations performed by the program modules have been described previously with the aid of one or more block diagrams and operational flowcharts.

Those skilled in the art can implement the description, block diagrams, and operational flows in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

The computing device 500 illustrated in FIG. 5, in its most basic configuration, includes at least one processing unit 502 and memory 504. In some implementations, the computing device 500 may implement at least part of, for example, one of the endpoints described previously, for example, with reference to FIG. 1. In some implementations, the processing unit 502 may be a general purpose central processing unit (CPU), as exists, for example, on a variety of computers, including desktop and laptop computers. Depending on the exact configuration and type of computing device, the memory 504 may be volatile (such as RAM), non-volatile (such as ROM, flash memory, etc.), or some combination of the two. This most basic configuration is illustrated in FIG. 5 by dashed line 506. Additionally, the computing device 500 may also have additional features and functionality. For example, the computing device 500 may also include additional storage (removable and/or non-removable) including, but not limited to, magnetic or optical disks or tape. Such additional storage is illustrated in FIG. 5 by the removable storage 508 and the non-removable storage 510.

The computing device 500 may also contain one or more communications connection(s) 512 that enable the computing device 500 to communicate with other devices and services. For example, the computing device might have one or more connections to other computing devices, including, for example, the endpoints described previously with reference to FIG. 1. The computing device 500 may also have one or more input device(s) 514 such as an image input devices like cameras or scanners, keyboards, mice, pens, voice input devices including microphone arrays, touch input devices, and so on. One or more output device(s) 516 such as a display, speakers, printer, and so on, may also be included in the computing device 500.

Those skilled in the art will appreciate that the technologies described herein may be practiced with computing devices other than the computing device 500 illustrated in FIG. 5. For example, and without limitation, the technologies described herein may likewise be practiced in hand-held devices including mobile telephones and PDAs, multiprocessor systems, microprocessor-based or programmable consumer electronics, network PCs, minicomputers, mainframe computers, and the like. Each of these computing devices may be described, at some level of detail, by the system of FIG. 5, or may be described differently.

The technologies described herein may also be implemented in distributed computing environments where operations are performed by remote processing devices that are linked through a communications network. In a distributed computing environment, program modules may be located in both local and remote devices.

While described herein as being implemented in software, it will further be appreciated that the technologies described herein may alternatively be implemented all or in part as hardware, firmware, or various combinations of software, hardware, and/or firmware.

Although some particular implementations of methods and systems have been illustrated in the accompanying drawings and described in the foregoing text, it will be understood that the methods and systems shown and described are not limited to the particular implementations described, but are capable of numerous rearrangements, modifications and substitutions without departing from the spirit set forth and defined by the following claims.

What is claimed is:

1. A method, comprising:
defining a schema definition in a feed document, wherein the schema definition comprises a field and the field comprises an element reference; and
defining an item in the feed document, wherein the item comprises a schema reference to the schema definition and an element that is associated with the element reference.

2. The method of claim 1 wherein the schema definition further comprises at least one of the following: an identifier that uniquely identifies the field, a required value that defines whether the element associated with the field is required to contain a valid value, a field deleted value that defines whether the field is no longer a valid part of the schema definition for creating a new item or editing an existing item, and a type value that defines a data type of an element value associated with the element.

3. The method of claim 1 wherein the schema definition further comprises at least one of the following: a unique identifier that identifies the schema definition, a schema definition deleted value that defines whether the schema definition is no longer valid for creating a new item or editing an existing item, a title field identifier that references a second field wherein the second field comprises a second element reference to a second element and a second element value associated with the second element is used to set a title of the item, and a description field identifier that references a third field wherein the third field comprises a third element reference to a third element and a third element value associated with the third element is used to set a description of the item.

4. The method of claim 1 wherein the schema definition further comprises a type value that defines a data type of an element value associated with the element, the data type is non-scalar, and the element value comprises a serialized object.

5. The method of claim 1 wherein the feed document further comprises a default schema definition value that identifies the schema definition and wherein the schema reference is assumed to be to the schema definition if no schema reference is explicitly specified with the item.

6. The method of claim 1, further comprising:
defining a second schema definition in the feed document, wherein the second schema definition comprises a second field and the second field comprises a second element reference, and the schema definition and the second schema definition are different; and
defining a second item in the feed document, wherein the second item comprises a second schema reference to one of the schema definition and the second schema definition.

7. The method of claim 1 wherein the document is in one of the RSS format and the Atom format.

8. The method of claim 1 wherein the document is in the RSS format and the schema definition is defined as an RSS namespace extension.

9. The method of claim 1 wherein the element is part of a basic set of elements defined by a format used by the feed document when the field does not include a namespace identifier.

10. The method of claim 1, further comprising one of the following operations performed after the schema has been defined and after the item has been defined:
adding a new schema definition to the feed document, wherein the new schema definition comprises a second field and the second field comprises a second element reference, and the schema definition and the new schema definition are different;
marking the schema definition as no longer valid for creating a new item or editing an existing item, by setting a schema definition deleted value to true;
adding a new namespace definition to the schema definition;
marking a second namespace definition as no longer valid for creating a second new item or editing a second existing item, by setting a namespace definition deleted value to true;
adding a new field to the schema definition, wherein the new field comprises a third element reference, and the field and the new field are different; and
marking the field as no longer valid for creating a third new item or editing a third existing item, by setting a field deleted value to true.

11. The method of claim 1, further comprising:
defining synchronization data in the feed document wherein the synchronization data enables the feed document to serve as a transfer mechanism for a bi-directional data synchronization relationship between a first endpoint and a second endpoint and wherein both the first endpoint and the second endpoint may make changes to data associated with the item and synchronize those changes by transferring the feed document.

12. A method, comprising:
accessing a feed document that comprises a schema definition and an item, wherein the schema definition comprises a field and the field comprises an element reference, and the item comprises a schema reference to the schema definition and an element that is associated with the element reference; and
processing the schema definition.

13. The method of claim 12 wherein the processing operation further comprises:
generating a user interface that comprises a user interface field wherein the user interface field is associated with the field and the user interface field is associated with the element.

14. The method of claim 12 wherein the processing operation further comprises:
providing an application programming interface that enables a user of the application programming interface to retrieve and to set a value associated with the element.

15. The method of claim 14 wherein the application programming interface further enables the user to access metadata associated with the field and with the element, and wherein the metadata comprises at least one of: a type associated with the field, a human-readable label associated with the field, and a required value that defines whether the element is required to contain a valid value.

16. The method of claim 12, further comprising one of the following operations performed on an endpoint after the feed document has been accessed on the endpoint:
determining that a new schema definition has been added by examining each schema definition in the feed document and identifying the new schema definition when the new schema definition has a unique schema definition identifier that is not already known by the endpoint;
determining a deleted schema definition by examining each schema definition in the feed document and identifying the deleted schema definition when the deleted schema definition has a schema definition deleted value that is set to true;
determining that a new namespace definition has been added by examining each namespace definition in the feed document and identifying the new namespace definition when the new namespace definition has a unique namespace definition identifier that is not already known by the endpoint;
determining a deleted namespace definition by examining each namespace definition in the feed document and identifying the deleted namespace definition when the deleted namespace definition has a namespace definition deleted value that is set to true;
determining that a new field has been added by examining each field in the feed document and identifying the new field when the new field has a unique field identifier that is not already known by the endpoint; and
determining a deleted field by examining each field in the feed document and identifying the deleted field when the deleted field has a field deleted value that is set to true.

17. The method of claim 12 wherein the feed document further comprises:
a second schema definition, wherein the second schema definition comprises a second field and the second field comprises a second element reference, and the schema definition and the second schema definition are different; and
a second item, wherein the second item comprises a second schema reference to one of the schema definition and the second schema definition.

18. The method of claim 12 wherein the schema definition further comprises at least one of the following: an identifier that uniquely identifies the field, a required value that defines whether the element associated with the field is required to contain a valid value, a field deleted value that defines whether the field is no longer a valid part of the schema definition for creating a new item or editing an existing item, and a type value that defines a data type of an element value associated with the element.

19. The method of claim 12 wherein the schema definition further comprises at least one of the following: a unique identifier that identifies the schema definition, a schema definition deleted value that defines whether the schema definition is no longer valid for creating a new item or editing an existing item, a title field identifier that references a second field wherein the second field comprises a second element reference to a second element and a second element value associated with the second element is used to set a title of the item, and a description field identifier that references a third field wherein the third field comprises a third element reference to a third element and a third element value associated with the third element is used to set a description of the item.

20. A system, comprising:
a document that comprises:
a schema definition that comprises a field wherein the field comprises an element reference, and
an item that comprises a schema reference to the schema definition and an element that is associated with the element reference; and
an endpoint configured to perform at least one of the following operations:
define the schema definition in the document,
define the item in the document, and
process the schema definition.
